(19) United States
(12) Patent Application Publication
(10) Pub. No.: US 2012/0124269 A1
(43) Pub. Date: May 17, 2012

(54) Organizing Memory for Effective Memory Power Management

(75) Inventors: Ankita Garg, Bangalore (IN); Balbir Singh, Bangalore (IN); Vaidyanathan Srinivasan, Bangalore (IN)

(73) Assignee: INTERNATIONAL BUSINESS MACHINES CORPORATION, Armonk, NY (US)

(21) Appl. No.: 12/946,409

(22) Filed: Nov. 15, 2010

(51) Int. Cl. G06F 12/00

(52) U.S. Cl. 711/6; 711/E12.016

(57) ABSTRACT

A kernel of the operating system reorganizes a plurality of memory units into a plurality of virtual nodes in a virtual non-uniform memory access architecture in response to receiving a configuration of the plurality of memory units from a firmware. A subsystem of the operating system determines an order of allocation of the plurality of virtual nodes calculated to maintain a maximum number of the plurality of memory units devoid of references. The memory controller transitions one or more memory units into a lower power state in response to the one or more memory units being devoid of one or more references for the period of time.

### BACKGROUND

1. Field

The disclosure relates generally to data processing, and more specifically, to modifying a computer kernel to make decisions in regard to memory power management.

2. Description of Related Art

In shared-memory multiprocessor computing systems, memory consumes a significant portion of the computing system's power. Memory management algorithms in shared memory multiprocessor computers may divide memory into modules physically placed near each processor to increase performance but that can also be accessed by other processors. Because the memory access time differs based on memory location, distributed shared memory systems are often called non-uniform memory access (NUMA) machines. Multiprocessor computers with distributed shared memory are often organized into multiple nodes with one or more processors per node. The nodes interface with each other through a memory interconnect network by using a protocol such as the protocol described in the Scalable Coherent Interface (SCI) (IEEE 1956).

A single operating system typically controls the operation of multi-node processor computer with distributed shared memory. The central processing unit and its memory communicate through an operating system having a kernel that controls the computer system's resources and schedules user requests.

Current memory hardware may transition areas of memory from one power state to another power state. A transition from one power state to another power state may be made in response to determining to which areas of the memory hardware the operating system is allocating memory. The allocations of memory to areas of the memory hardware results in references to the areas of the memory hardware. Such transitions by current memory hardware are initiated by the memory hardware itself without cooperation with the operating system for power saving.

### BRIEF SUMMARY

A kernel of the operating system reorganizes a plurality of memory units into a plurality of virtual nodes in a virtual non-uniform memory access architecture in response to receiving a configuration of the plurality of memory units from a firmware. A subsystem of an operating system determines an order of allocation of a plurality of virtual nodes calculated to maintain a maximum number of the plurality of memory units devoid of references. A memory controller transitions one or more memory units into a lower power state in response to the one or more memory units being devoid of one or more references for the period of time. In an illustrative embodiment, a memory reclaim is performed with a virtual node before an attempt is made to allocate memory from a different virtual node. In a further illustrative embodiment, a policy brings a virtual node, that has been taken off line, back online in order to meet a performance criteria.

### BRIEF DESCRIPTION OF THE SEVERAL VIEWS OF THE DRAWINGS

The novel features believed characteristic of the illustrative embodiments are set forth in the appended claims. The illustrative embodiments themselves, however, as well as a preferred mode of use, further objectives and advantages thereof, will best be understood by reference to the following detailed description of the illustrative embodiments when read in conjunction with the accompanying drawings, wherein:

FIG. 1 is an illustrative diagram of a data processing environment in which illustrative embodiments may be implemented;

FIG. 2 is an illustration of a data processing system depicted in accordance with an illustrative embodiment;

FIG. 3 is a computing system in which the illustrative embodiments may be implemented;

FIG. 4 is a dual inline memory module depicted in accordance with an illustrative embodiment;

FIG. 5 is an illustration of real nodes depicted in accordance with an illustrative embodiment;

FIG. 6 is an illustration of virtual nodes depicted in accordance with an illustrative embodiment;

FIG. 7 is a flowchart of a power saving process depicted in accordance with an illustrative embodiment; and

FIG. 8 is a flowchart of a power saving configuration process depicted in accordance with an illustrative embodiment.

### DETAILED DESCRIPTION

The illustrative embodiments recognize and take into account that a need exists to organize memory hardware to take advantage of a capability of the memory hardware to transition memory units in the memory hardware from one power state to another state. The illustrative embodiments recognize and take into account that the operating system may be configured to allocate memory units in the memory hardware in an order that will cause memory units at the top of the list to be referenced first and memory units at the bottom of the list to be referenced last. The illustrative embodiments recognize and take into account that such a list may keep a maximum number of memory units in the memory hardware devoid of references for a period of time. The illustrative embodiments recognize and take into account that in response to a memory unit of the memory hardware being kept devoid of references for the period of time, a memory controller of the memory hardware may move the memory unit to a lower level of power consumption in accordance with a configuration of the memory hardware and a logic of the memory controller for automatically transitioning memory units among different power states.

The illustrative embodiments recognize and take into account that a method, computer system, and computer program product for saving power in a memory hardware may comprise a firmware identifying a plurality of memory units in a memory hardware, wherein each of the plurality of memory units is a portion of the memory hardware configured for power management by a memory controller of the memory hardware in response to the portion of the memory hardware being devoid of references for a period of time. The firmware identifies a configuration of the plurality of memory units and sends the configuration to an operating system. A kernel of the operating system reorganizes the plurality of memory units into a plurality of virtual nodes in a virtual non-uniform memory access architecture in response to receiving the configuration. A subsystem of the operating system determines an order of allocation of the plurality of virtual nodes calculated to maintain a maximum number of the plurality of memory units devoid of references. The memory controller transitions one or more memory units into a lower power state in response to the one or more memory units being devoid of one or more references for the period of time.

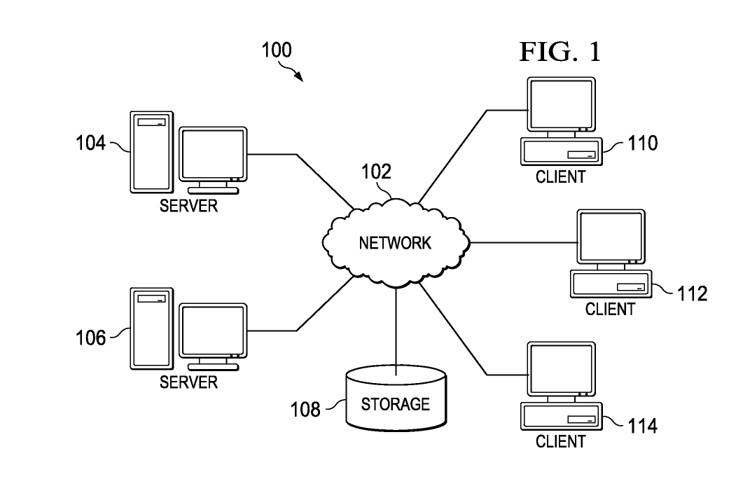

With reference now to the figures, and in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

Referring to FIG. 1 depicts a pictorial representation of a network of data processing systems in which illustrative embodiments may be implemented. Network data processing system 100 may be a network of computers in which the illustrative embodiments may be implemented. Network data processing system 100 contains network 102, which may be the medium used to provide communication links between various devices and computers operably coupled together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Program code located in network data processing system 100 may be stored on a computer recordable storage device and downloaded to a data processing system or other device for use. For example, program code may be stored on a computer recordable storage device on server computer 104 and downloaded to client computer 110 over network 102 for use on client computer 110.

In the depicted example, network data processing system 100 may be the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as an intranet, a local area network (LAN), or a wide area network (WAN). FIG. 1 is intended as an example, and not as an architectural limitation for the different illustrative embodiments.

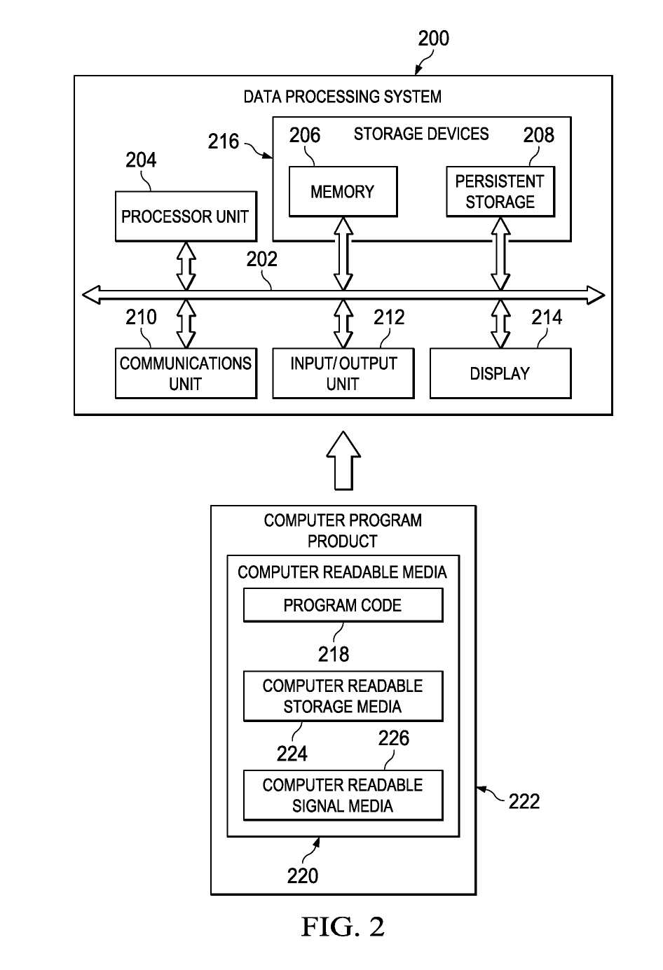

Turning now to FIG. 2, an illustration of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214.

Processor unit 204 serves to run instructions for software that may be loaded into memory 206. Processor unit 204 may be a number of processors, a multi-processor core, or some other type of processor, depending on the particular implementation. A number, as used herein with reference to an item, means one or more items. Further, processor unit 204 may be implemented using a number of heterogeneous processor systems in which a main processor may be present with secondary processors on a single chip. As another illustrative example, processor unit 204 may be a symmetric multi-processor system containing multiple processors of the same type.

Memory 206 and persistent storage 208 are examples of storage devices 216. A storage device may be any memory unit of hardware that may be capable of storing information, such as, for example, without limitation, data, program code in functional form, and/or other suitable information either on a temporary basis and/or a permanent basis. Storage devices 216 may also be referred to as computer readable storage devices in these examples. Memory 206, in these examples, may be, for example, a random access memory or any other suitable volatile or non-volatile storage device, with power management features like support for various lower power states. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The medium used by persistent storage 208 also may be removable. For example, a removable hard drive may be used for persistent storage 208.

Communications unit 210, in these examples, provides for communications with other data processing systems or devices. In these examples, communications unit 210 may be a network interface card. Communications unit 210 may provide communications through the use of either or both physical and wireless communications links.

Input/output unit 212 allows for input and output of data with other devices that may be operably coupled to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for running by processor unit 204. The processes of the different embodiments may be performed by processor unit 204 using computer implemented instructions, which may be located in a memory, such as memory 206.

These instructions are referred to as program code, computer usable program code, or computer readable program code that may be read and run by a processor in processor unit 204. The program code in the different embodiments may be embodied on different physical or computer readable storage medium, such as memory 206 or persistent storage 208.

Program code 218 may be located in a functional form on computer readable medium 220 that may be selectively removable and may be loaded onto or transferred to data processing system 200 for running by processor unit 204. Program code 218 and computer readable medium 220 form computer program product 222 in these examples. In one example, computer readable medium 220 may be computer readable storage medium 224 or computer readable signal medium 226. Computer readable storage medium 224 may include, for example, an optical or magnetic disk that may be inserted or placed into a drive or other device that may be part of persistent storage 208 for transfer onto a computer readable storage device, such as a hard drive, that may be part of persistent storage 208.

Computer readable storage medium 224 also may take the form of a persistent storage, such as a hard drive, a thumb drive, or a flash memory, that may be operably coupled to data processing system 200. In some instances, computer readable storage medium 224 may not be removable from data processing system 200. In these illustrative examples, computer readable storage medium 224 may be a non-transitory computer readable storage medium.

Alternatively, program code 218 may be transferred to data processing system 200 using computer readable signal medium 226. Computer readable signal medium 226 may be, for example, a propagated data signal containing program code 218. For example, computer readable signal medium 226 may be an electromagnetic signal, an optical signal, and/or any other suitable type of signal. These signals may be transmitted over communication links, such as wireless communication links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal medium 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown.

The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

As another example, a storage device in data processing system 200 may be any hardware apparatus that may store data. Memory 206, persistent storage 208, and computer readable medium 220 are examples of storage devices in a tangible form. In another example, a bus system may be used to implement communications fabric 202 and may be comprised of one or more buses, such as a system bus or an input/output bus.

Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206, or a cache, such as found in an interface and memory controller hub that may be present in communications fabric 202.

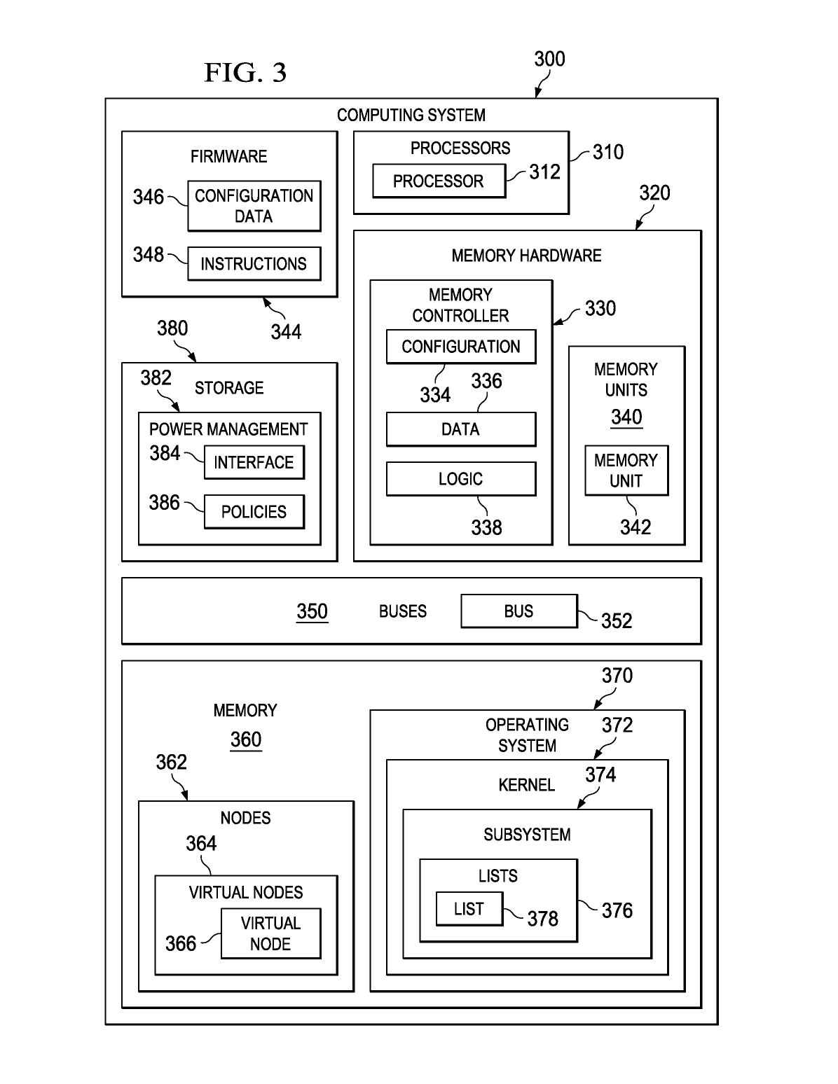

Referring to FIG. 3, a computing system in which the illustrative embodiments may be implemented is disclosed. Computing system 300 comprises processors 310, memory hardware 320, firmware 344, memory 360, and storage 380. Processors 310 may comprise a number of processors such as processor 312. As used herein, the term “processor” means a central processing unit which may comprise one or more processors such as processor 312. Memory hardware 320 may comprise memory controller 330 and memory units 340. Memory controller 330 may comprise configuration 334, data 336, and logic 338. Configuration 334 may be the physical structure of memory hardware 320. Data 336 may comprise a number of time values and a topology of memory hardware 320. In an illustrative embodiment, a topology may comprise a number of start addresses and a number of sizes of each of the number of memory units of memory hardware. In an illustrative embodiment, the time value may be a period of time for which a memory unit has been devoid of references. In another illustrative embodiment, the time value may be a rate that pages are referred to each memory unit of memory hardware 320 by an operating system. Persons skilled in the art are aware of a number of time values, thresholds, events, and occurrences that may be detected by memory controller 330 and for which memory controller 330 may be configured to move a memory unit from one power state to another power state.

In an illustrative embodiment, memory hardware 320 may be a memory hardware such as a computer readable storage device as in FIG. 1 and FIG. 2. In other illustrative embodiments, memory hardware 320 may be any memory hardware configured to change a power status of one or more memory units in accordance with the time value. Memory units 340 may be individual memory units of memory within memory hardware 320. An individual memory unit may be a memory unit such as memory unit 342 in memory units 340 of memory hardware 320. As used herein, memory unit means a portion of memory hardware such as memory hardware 320 configured for power management by a memory controller such as memory controller 330 in response to the portion of the memory hardware being devoid of references for a period of time. Firmware 344 may comprise configuration data 346 and instructions 348. Configuration data 348 may comprise configuration data from a number of memory controllers in a number of memory hardware.

As used herein, firmware may comprise computer programming instructions such as instructions 348 and configuration data such a configuration data 346 associated with a number of memory hardware such as memory hardware 320. Firmware 344 may obtain configuration data from configuration 334 of memory controller 330 of memory hardware 334. Firmware 334 may identify a plurality of memory units such as memory units 340 from configuration 334. Each of memory units 340 are configured to be transitioned between each of a plurality of power states by memory controller 330 in response to a time value. Data 336 of memory controller 330 may contain one or more time values associated with memory units 340. Firmware 344 may identify a topology of memory units 340 of memory hardware 320 from data 336 and store the topology in configuration data 346. Firmware 344 may identify a time value for each of the plurality of memory units 340 from data 336 and store the time values in configuration data 346. Instructions 348 of firmware 344 may send kernel 372 of operating system 370 configuration data 346 to inform kernel 372 of the quantity of memory units 340 in memory hardware 320. Instructions 348 of firmware 344 may send configuration data 346 to kernel 372 to inform kernel 372 of the topology of memory units 340. Instructions 346 of firmware 344 may send configuration data 346 to inform kernel 372, subsystem 374, or both kernel 372 and subsystem 374 of a time value for each of the plurality of memory units 340.

The illustrative embodiments recognize and take into account that to organize memory units 340 of memory hardware 320 for power saving, operating system 370 must be aware of configuration 334 of memory units 340. Such awareness by operating system 370 may be achieved by exporting configuration data 346 regarding configuration 334 of memory units 340 to operating system 370. Configuration data 346 may be exported to operating system 370 by instructions 348 in firmware 344. Once operating system 370 has received configuration data 346 from firmware 344, operating system 370 may allocate memory in such a way that at any given time, the references are consolidated to keep a maximum number of memory units 340 devoid of references.

The illustrative embodiments recognize and take into account that keeping a maximum number of memory units devoid of references may be an effective technique to conserve power consumption by memory hardware such as memory hardware 320. The illustrative embodiments recognize and take into account that in order to keep a maximum number of memory units devoid of references may require an operating system configured to allocate memory from memory hardware 320 and memory controller 330 with a particular granularity in a manner that may keep a maximum number of memory units devoid of references. In an illustrative embodiment, a kernel reorganizes a plurality of memory units into a plurality of virtual nodes. In a smallest granularity there may be one memory unit per virtual node. In a larger granularity, there may be a number of memory units within a virtual node. When there are a number of memory units within a virtual node, the memory units may be ordered in a well-defined list. As used herein, a well-defined list means a list prepared by the subsystem of the operating system to keep a maximum number of memory units devoid of references and may include accommodating a number of polices in regard to power saving.

In an embodiment, configuration data 346 of firmware 344 may include a topology of memory hardware 320. The illustrative embodiments recognize and take into account that firmware 344 associated with memory hardware 320 may comprise instructions 348 for sending configuration data 346 to a subsystem 374 in kernel 372 of operating system 370. The illustrative embodiments further recognize that once instructions 348 have informed subsystem 374 in kernel 372 of operating system 370 of configuration data 346 for a particular memory hardware such as memory hardware 320, subsystem 374 may allocate memory through virtual nodes 364 in such a way that logic 338 of memory controller 330 may cause a memory unit such as memory unit 342 to move from a first state of power consumption to a second state of power consumption.

The illustrative embodiments recognize and take into account that logic 338 may respond to an amount of time that a memory unit such as memory unit 342 remains devoid of references. In an embodiment, a time that a memory unit, such as memory unit 342, remains devoid of references, may be included in configuration data 346 of firmware 344. A time that a memory unit may be devoid of references may be included in configuration data by power management 382, or may be established by policies 386 in power management 382. Power management 382 may be a program providing an interface such as interface 384 for configuring operating system 370 and memory hardware 320 for power management in accordance with a virtual organization of memory units 340.

The illustrative embodiments recognize and take into account that memory units 340 may be aligned to virtual non-uniform memory access nodes such as virtual nodes 364. As used herein, the term “node” means a non-uniform memory access node. As used herein, the term “virtual node” means a virtual non-uniform memory access node. Once firmware 344 exports configuration data 346 about memory units 340, subsystem 374 of kernel 372 may create virtual nodes across the boundaries of memory units 340. In an illustrative embodiment, configuration data 346 may include a start address and a size of a memory unit. Memory 360 may comprise nodes 362 and operating system 370. Nodes 362 may comprise a number of virtual nodes 364 such as virtual node 366. Virtual node 366 may be associated with a memory unit such as memory unit 342 in memory hardware 320 by subsystem 374 of operating system 370. Each of the number of virtual nodes 364 may be managed independently by subsystem 374 for controlling consumption of power by allocating memory to virtual nodes 364. Each of virtual nodes 364 may be associated with a memory unit such as memory unit 342.

Subsystem 374 of kernel 372 may organize virtual nodes 364 into lists 376 so that a virtual node such as virtual node 366 may be listed on a list such as list 378 in lists 376. Lists 376 may be configured as a plurality of well defined lists. List 378 may be configured as a well defined list. List 378 may contain a number of virtual nodes such as virtual node 366 in an order of virtual nodes so that subsystem 374 of kernel 372 may assign memory units in accordance with the order of virtual nodes in list 378. Assigning memory in accordance with an order of a list such as list 378 may allow operating system 370 to allocate memory to memory units such as memory units 340 in a well-defined order so that the memory units 340 are filled such that the ones with higher references are filled first and the ones with lower references are kept empty or devoid of references until the ones with higher references are filled.

In an illustrative embodiment, operating system 370 may reclaim memory units from a first virtual node for allocation before allocating references to a second virtual node. In an illustrative embodiment, a memory unit that contains data but that has not been referenced in a period of time may be reclaimed by a page migration so that the memory unit will be devoid of references. In the illustrative embodiment, a page migration may move a page from a first virtual node to a second virtual node by copying the page from the memory unit associated with the first virtual node over to a second memory unit associated with the second virtual node and changing a mapping of the page to reflect the new location of the page in the second memory unit. In an illustrative embodiment, reclaiming of memory units may be performed at run time where the reclamation may be triggered based on system load and memory utilization. In another illustrative embodiment, reclaiming of memory units may be performed at a periodic interval. In another illustrative embodiment, reclaiming of memory units may be performed at run time, where the reclamation is triggered based on system load and memory utilization and may also be performed at a number of periodic intervals.

Operating system 370 may comprise kernel 372. Kernel 372 may comprise subsystem 374. In an illustrative embodiment, subsystem 374 may organize memory units 340 in a virtual organization of virtual nodes such as virtual nodes 364. The illustrative embodiments recognize and take into account that a kernel may be modified. One way in which a kernel may be modified may be by installing a subsystem such as subsystem 374. Alternatively, operating system 370 may be formed with subsystem 374 as an integral part of operating system 370. Subsystem 374 may receive configuration data 346 from firmware 344. Subsystem 374, in response to receiving configuration data 346 from firmware 344, forms a number of virtual nodes such as virtual nodes 364. The illustrative embodiments recognize and take into account that virtual nodes, such as virtual nodes 366, may be organized taking into account the physical memory configuration of memory units such as memory units 342 in order to manage power consumption. The illustrative embodiments recognize and take into account that a subsystem, such as subsystem 374 of kernel 372, may comprise a virtual memory manager, such as LINUX® virtual memory manager, that allows kernel 372 to abstract a physical hardware layout of memory represented by configuration data 346 for memory units 340.

The illustrative embodiments recognize and take into account that such an abstraction of the physical hardware layout of memory units 340 may allocate memory across different memory units of memory units 340. Such spreading of allocations across different memory units of memory units 340 may prevent memory management software such as power management 382 from taking advantage of the memory hardware features for placing memory units 340 into lower power states depending on logic 338 in memory controller 330. In an illustrative embodiment, logic 338 may move a memory unit such as memory unit 342 into a lower power state based on a time that memory unit 342 remains devoid of references. In an illustrative embodiment, a time that memory unit 342 remains devoid of references may be expressed in seconds or fractions of a second. In another embodiment, a time that memory unit 342 remains devoid of references may be expressed as a rate at which references are made to memory units 340. In order to exploit the memory hardware features such as logic 338 in memory controller 330, kernel 372 may organize memory units 340 in a virtual memory layer comprising virtual nodes 364 in order for subsystem 374 to allocate memory units 340 to save power. For example, virtual nodes 366 may be organized to keep a maximum number of memory units 340 idle, so that logic 338 changes a power state of one or more memory units such as memory unit 342.

Buses 350 may include a bus, such as bus 352, for linking processors 310 to memory hardware 320. Storage 380 may comprise power management 382. Power management 382 may comprise interface 384 and policies 386. Interface 384 may enable a user to provide policies in regard to allocation of memory units by subsystem 374. Policies such as policies 386 may permit different power management modes for accommodating performance issues. In an illustrative embodiment, policies are based on the fact that, for most memory controllers, if a memory unit is actively being referenced, the memory unit will not be moved to a lower power state and thus there will be no power saving.

In an illustrative embodiment, a memory controller transitions a memory unit to a lower power state when there have been no references to the memory unit for a period of time. The period of time may be referred to as a threshold. Thus policies are designed to ensure that memory allocations do not get spread across different memory units. The policies may be designed to pack and consolidate allocations into a single memory unit before spreading allocation to the next memory unit in line in the allocation order or on the list of virtual nodes. The effect of the foregoing will cause references to be consolidated to one memory unit so that other units may be able to enter a lower power state. Policies are designed to take into account that if a memory unit is full, meaning that it has no free memory, memory may be reclaimed from the memory unit without affecting performance, and in such a case memory may be reclaimed from the memory unit and that reclaimed memory allocated before allocating to the next memory unit in line. In an illustrative embodiment, one or more instructions of instructions 348 may be incorporated into memory controller 330 or into subsystem 374.

In an illustrative embodiment, a plurality of power management policies may be stored in policies 386. Each of the plurality of power management policies stored in policies 386 may be configured to cause the system to decide on a mechanism to be used to save power. In an illustrative embodiment, the mechanisms may take an acceptable performance impact into account. The plurality of power management policies in policies 386 may include an aggressive power save policy, wherein the aggressive power save policy allocates a plurality of virtual nodes according to a list of virtual nodes so that a particular memory unit associated with a virtual node at or near a top of the list will be most heavily referenced and another memory unit associated with a virtual node at or near the bottom of the list will be least referenced. In addition to the above arrangement, aggressive power save policy may consolidate references at periodic intervals by reclamation and migration of allocated memory units associated with the virtual nodes at near or bottom of the list so that the virtual nodes at or near the bottom of the list have the least memory references. Further, the aggressive power save policy may reduce the amount of virtual nodes available to the system using memory hot plug techniques so that memory units associated with unallocated virtual nodes are never referenced. The plurality of power management policies in policies 386 may include a power save policy, wherein the power save policy allocates a plurality of virtual nodes according to the list of virtual nodes so that a particular memory unit associated with a virtual node at or near a top of the list will be most heavily referenced and another memory unit associated with a virtual node at or near the bottom of the list will be least referenced. In addition to the above arrangement, the power save policy consolidates references to available memory by reclamation and migration of allocated memory units in virtual nodes in the order of the list at run time, at a periodic interval, or at run time and at a periodic interval, or at a number of intervals in addition to run time.

The plurality of power management policies in policies 386 may include a balanced power save policy, wherein the balanced power save policy allocates virtual nodes in the order of the list so that a memory unit associated with a virtual node at or near a top of the list will be most heavily referenced and another memory unit associated with a virtual node at or near the bottom of the list will be least referenced. The plurality of power management policies in policies 386 may include a performance policy, wherein the performance mode causes the subsystem of the operating system to reclaim only clean pages within a virtual node before allocating a virtual node lower on the list, and may further comprise factoring a distance into a determination of the order of allocation in response to determining, by subsystem 374, the distance between memory units associated with each of the virtual nodes.

As used herein, distance may be a number of hops or latency involved in an interaction of a central processing unit and a memory unit in a virtual node. In an illustrative example, on a system with two virtual nodes, a memory unit in the range of eight to sixteen gigabytes may be two hops away for a processor in the first virtual node as compared to the first eight gigabytes of memory. A number of mechanisms may be employed in support of policies. In an illustrative example, “hot plugging” and “hot-unplugging” may be employed to take memory units on and off line. In an illustrative embodiment, run time balancing may be employed. As used herein, run time balancing means to consolidate references at run time. An illustrative example of a run time balancing mechanism may be page migration.

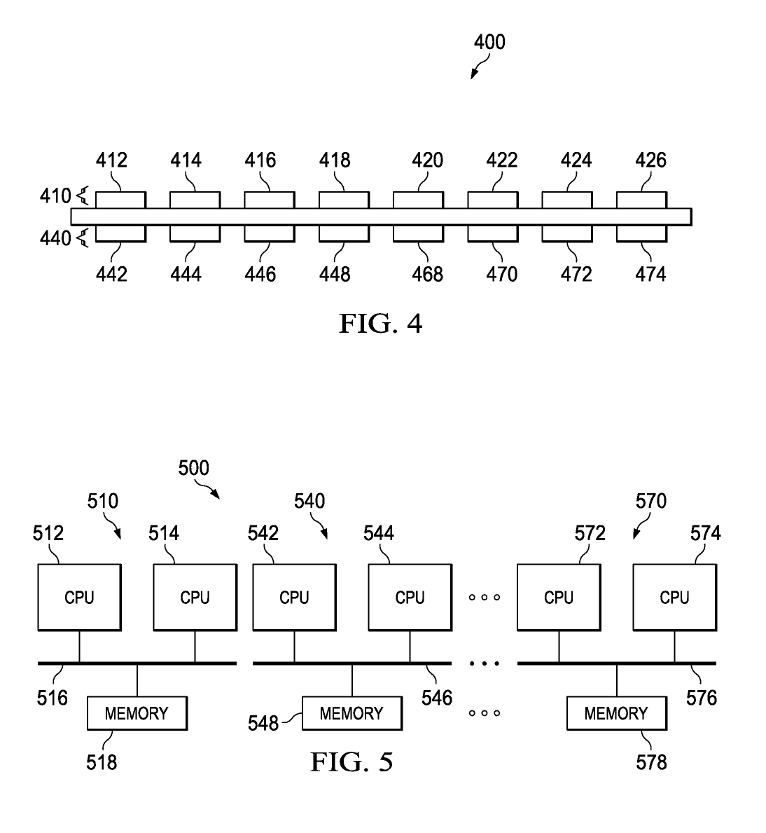

Referring to FIG. 4, a dual inline memory module is shown in accordance with an illustrative embodiment. The illustrative embodiments recognize and take into account that memory hardware 320 in FIG. 3 may be single data rate, double data rate, and dynamic random access memory architectures. The illustrative embodiments recognize and take into account that double data rate may be the most common memory architecture and that double data rate may be packaged in modules called dual inline memory modules. In addition, each dual inline memory module may contain one, two, or four memory ranks. Dual inline memory module 400 may be a memory hardware such as memory hardware 320 in FIG. 3. Dual inline memory module 400 has first rank 410 and second rank 440. First rank 410 may be a memory unit such as memory unit 342 in FIG. 3. Second rank 440 may be a memory unit such a memory unit 342 in FIG. 3. In an embodiment, memory units 340 may comprise segments such as segments 412 through 426 in first rank 410 and segments 442 through 474 in second rank 440.

The illustrative embodiments recognize and take into account that memory management algorithms in subsystem 374 of operating system 370 in FIG. 3 may allocate and deallocate memory from dual inline memory modules such as dual inline memory module 400 in accordance with a number of virtual nodes such as virtual nodes 364 in FIG. 3 in order to keep a maximum number of memory units such as first rank 410 and second rank 440 devoid of references. The illustrative embodiments recognize and take into account that first rank 410 and second rank 440 may be configured for performance and not for power consumption. The illustrative embodiments further recognize and take into account that subsystem 374 in FIG. 3 may organize first rank 410 and second rank 440 into a number of virtual nodes such as virtual nodes 364. Thus, in an illustrative embodiment, dual in-line memory module 400 may be organized into a virtual memory layer comprising virtual nodes such as virtual nodes 364 by subsystem 374 from data 336 sent to subsystem 374 in operating system 370 in FIG. 3.

In an illustrative embodiment, virtual nodes 364 may be aligned to a number of different ranks in a number of different memory hardware such as dual inline memory module 400. Configuration data 346 in FIG. 3 may comprise information about a number of different ranks in a number of different memory hardware. Information in configuration data 346 in FIG. 3 may further comprise information about a number of ranks of a number of dual inline memory modules, a number of memory controllers associated with the number of ranks of the number of dual inline memory modules and other hardware related to dual inline memory modules such as dual inline memory module 400.

Referring to FIG. 5, an illustration of real nodes is shown in accordance with an illustrative embodiment. Real nodes 500 may have first real node 510, second real node 540, and third real node 570. First real node 510 may have first processor 512 and second processor 514 linked to first memory hardware 518 by bus 516. Second real node 540 may have third processor 542 and fourth processor 544 linked to second memory hardware 548 by second bus 546. Third real node 570 may have fifth processor 572 and sixth processor 574 linked to third memory hardware 578 by third bus 576. In real nodes 500, each real node such as first real node 510, second real node 540, and third real node 570 may access a memory hardware that may be operably coupled to one of the other real nodes. The illustrative embodiments recognize and take into account that real nodes such as real nodes 500 may be organized for speed rather than for power consumption.

The illustrative embodiments recognize and take into account that access to memory hardware linked to processors within a node may be faster than accessing memory hardware in another node. First memory hardware 518, second memory hardware 548, and third memory hardware 578 may be memory hardware such as memory hardware 320 in FIG. 3. In an embodiment, first memory hardware 518, second memory hardware 548, and third memory hardware 578 may be a memory hardware such as dual inline memory module 400 in FIG. 4.

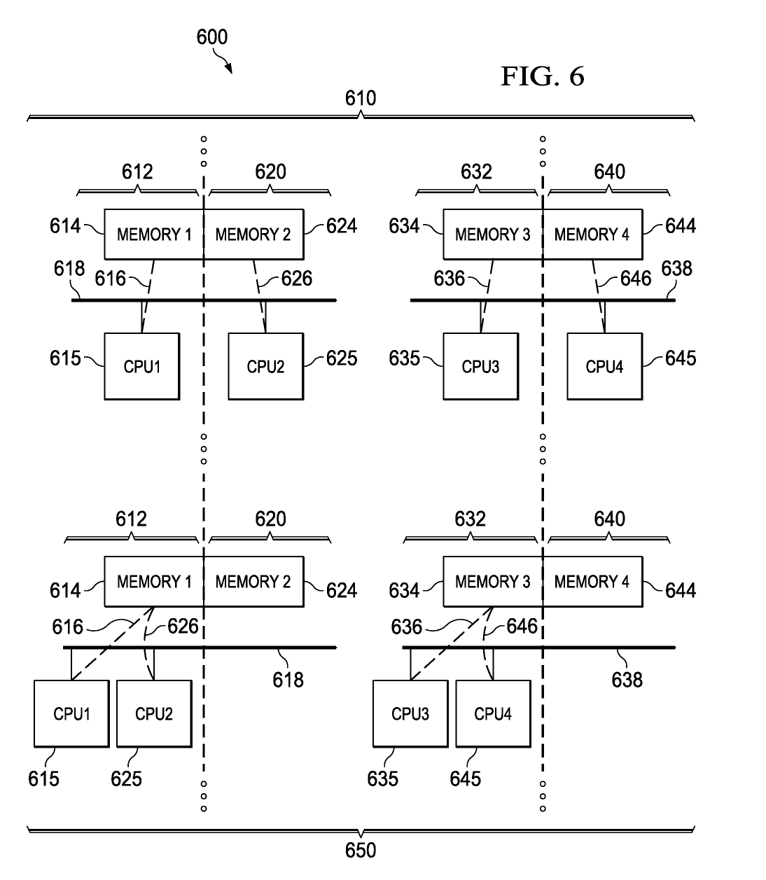

Referring to FIG. 6, an illustration of virtual nodes is shown in accordance with an illustrative embodiment. As used herein, the term virtual node means a virtual non-uniform memory access node. The illustrative embodiments recognize and take into account that multiple virtual nodes may be created out of each real node. In the illustrative embodiments, an operating system such as operating system 370 in FIG. 3 may have an awareness of real nodes replaced with an awareness of virtual nodes. In an illustrative embodiment, every data structure recognizing real nodes would be changed to recognize virtual nodes. By way of example, virtual nodes 600 have first exemplary configuration 610 and second exemplary configuration 650.

First exemplary configuration 610 may illustrate an application of virtual nodes to a real node such as first real node 510 in FIG. 5. First real node 510 of FIG. 5 may be divided into first virtual node 612 and second virtual node 620 in FIG. 6. First virtual node 612 and second virtual node 620 may correspond to first memory unit 614 and second memory unit 624. In first virtual node 612, first memory unit 614 may receive first data 616 from first processor 615 across first bus 618. In second virtual node 620, second memory unit 624 may receive second data 626 from second processor 625 across first bus 618. Likewise, in first exemplary configuration 610, second real node 540 in FIG. 5 may be divided into third virtual node 632 and fourth virtual node 640 as shown in FIG. 6. Third virtual node 632 and fourth virtual node 640 correspond to third memory unit 634 and fourth memory unit 644. In third virtual node 632, third memory unit 634 may receive third 636 from third processor 635 across first bus 638, and fourth memory unit 644 may receive fourth data 646 from fourth processor 645 across second bus 638.

In second exemplary configuration 650, first memory unit 614 in first virtual node 612 receives first data from first processor 615 and now also receives second data 626 from second processor 625. Second memory unit 624 receives no data. In response to second memory unit 624 remaining devoid of data for an amount of time, a power consumption of second memory unit 624 may be lowered. In like manner, in second exemplary configuration 650, third memory unit 634 receives third data 636 from third processor 635 but now also receives fourth data 646 from fourth processor 645. Fourth memory unit 644 receives no references. In response to fourth memory unit 644 remaining devoid of data for an amount of time, a power consumption of fourth memory unit 644 may be lowered.

The illustrative embodiments recognize and take into account that for each real node, free memory may be organized into lists, and that allocations within virtual nodes may be performed from the lists. Thus, referring to FIG. 6, allocations of memory in second exemplary configuration 650 may be made from a list in which all memory allocations in response to requests from first processor 615 and second processor 635 are made to first memory unit 614 until first memory unit 614 is filled in an order of the list until full and all memory allocations in response to requests from third processor 635 and fourth processor 645 are made to third memory unit 634 until third memory unit 634 is filled in an order of the list until filled. The illustrative embodiments recognize and take into account that in response to free memory in a node such as first memory unit 614 in first virtual node 612 or third memory unit 634 in third virtual node 632 falling below a particular threshold, a memory reclaim function may be performed. As used herein, memory reclaim means that free memory may be created by releasing allocated but unreferenced memory.

In the illustrative example of FIG. 6, a list may designate memory unit 614 to be filled before memory unit 624. Thus, in response to memory unit 614 becoming full, data references 616 and 636 from first processor 615 and second processor 625 may be sent to second memory unit 624 because second memory unit 624 would be next on a list. Likewise, in response to third memory unit 634 becoming full, data references 636 and 646 from third processor 635 and fourth processor 645 may be sent to fourth memory unit 644 because fourth memory unit 644 would be next on a list. The illustrative embodiments recognize and take into account that more than one virtual node may be selected as a candidate from which an allocation request may be satisfied. In the illustrative examples, any number of virtual nodes may be assigned in sequential order from a list such as list 378 in FIG. 3, thus causing memory allocation requests to be satisfied from any number of virtual nodes representing memory units of devises in memory hardware 320 of FIG. 3 in a sequential order of the list.

The illustrative embodiments recognize and take into account that a threshold for initiating memory reclaim in each node may be kept low, ensuring that more memory reclaim may be performed within a virtual node before allocation is satisfied from the next virtual node, so that references do not get sent to other virtual nodes until necessary. The illustrative embodiments recognize and take into account that with virtual nodes, references to ranks such as first rank 410 and second rank 440 in FIG. 4 may be reduced, making consolidation of references easier.

The illustrative embodiments recognize and take into account that in a system of real nodes, memory may be allocated across several memory units or several memory hardwares making consolidation of references difficult. However, firmware such as firmware 344 in FIG. 3 may inform a subsystem of an operating system such as subsystem 374 in operating system 370 of data 336 so that subsystem 374 may form virtual nodes 364. With virtual nodes such as virtual nodes 364, consolidation of references can be enhanced in a number of ways allowing a number of power management modes to be implemented. By way of example, second exemplary configuration 650 in FIG. 6 may illustrate one way of consolidating data by taking second virtual node 620 and fourth virtual node 640 offline so that data must be sent to first virtual node 612 and to third virtual node 632.

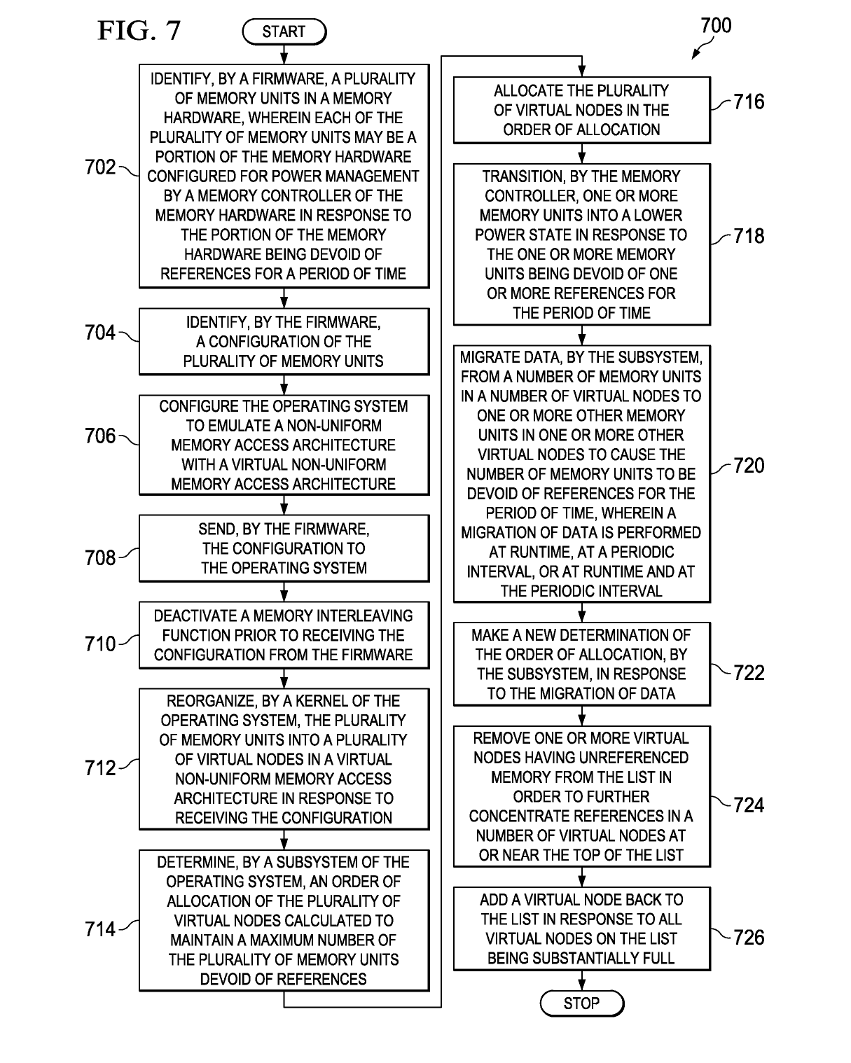

Referring to FIG. 7, a flowchart of a power saving process is disclosed in accordance with an illustrative embodiment. Process 700 starts and identifies, by a firmware, a plurality of memory units in a memory hardware, wherein each of the plurality of memory units may be a portion of the memory hardware configured for power management by a memory controller of the memory hardware in response to the portion of the memory hardware being devoid of references for a period of time (step 702). Memory hardware may be memory hardware 320 and memory units may be memory units 340 in FIG. 3. Memory controller may be memory controller 330 in FIG. 3.

Process 700 identifies, by the firmware, a configuration of the plurality of memory units (step 704). Process 700 configures the operating system to emulate a non-uniform memory access architecture with a virtual non-uniform memory access architecture (step 706). Process 700 sends, by the firmware, the configuration to the operating system (step 708). The configuration may be included in configuration data 346 in FIG. 3 and obtained from data 336 and configuration 334 in memory controller 330 by firmware 344 in FIG. 3. Process 700 may deactivate a memory interleaving function prior to receiving the configuration from the firmware (710). Process 700 reorganizes, by a kernel of the operating system, the plurality of memory units into a plurality of virtual nodes in a virtual non-uniform memory access architecture in response to receiving the configuration (step 712). The kernel may be kernel 372 and the virtual nodes may be virtual nodes 364 in FIG. 3. Process 700 determines, by a subsystem of the operating system, an order of allocation of the plurality of virtual nodes calculated to maintain a maximum number of the plurality of memory units devoid of references (step 714). Subsystem may be subsystem 374 in FIG. 3. Process 700 allocates the plurality of virtual nodes in the order of allocation (step 716). The order of allocation may be embodied in a list such as list 378 in FIG. 3. Process 700 transitions, by the memory controller, one or more memory units into a lower power state in response to the one or more memory units being devoid of one or more references for the period of time (step 718).

Process 700 may migrate data, by the subsystem, from a number of memory units in a number of virtual nodes to one or more other memory units in one or more other virtual nodes to cause the number of memory units to be devoid of references for the period of time, wherein a migration of data is performed at run time, at a periodic interval, or at run time and at the periodic interval (step 720). A specific technique for migrating data may be chosen depending on a particular power policy in policies 386 in power management 382. Persons skilled in the art that any number of power policies may be configured in accordance with a number of criteria. Process 700 may make a new determination of the order of allocation, by the subsystem, in response to the migration of data (step 722). Process 700 may remove one or more virtual nodes having unreferenced memory from the list in order to further concentrate references in a number of virtual nodes at or near the top of the list (step 724). Process 700 may add a virtual node back to the list in response to all virtual nodes on the list being substantially full (step 726). Process 700 stops.

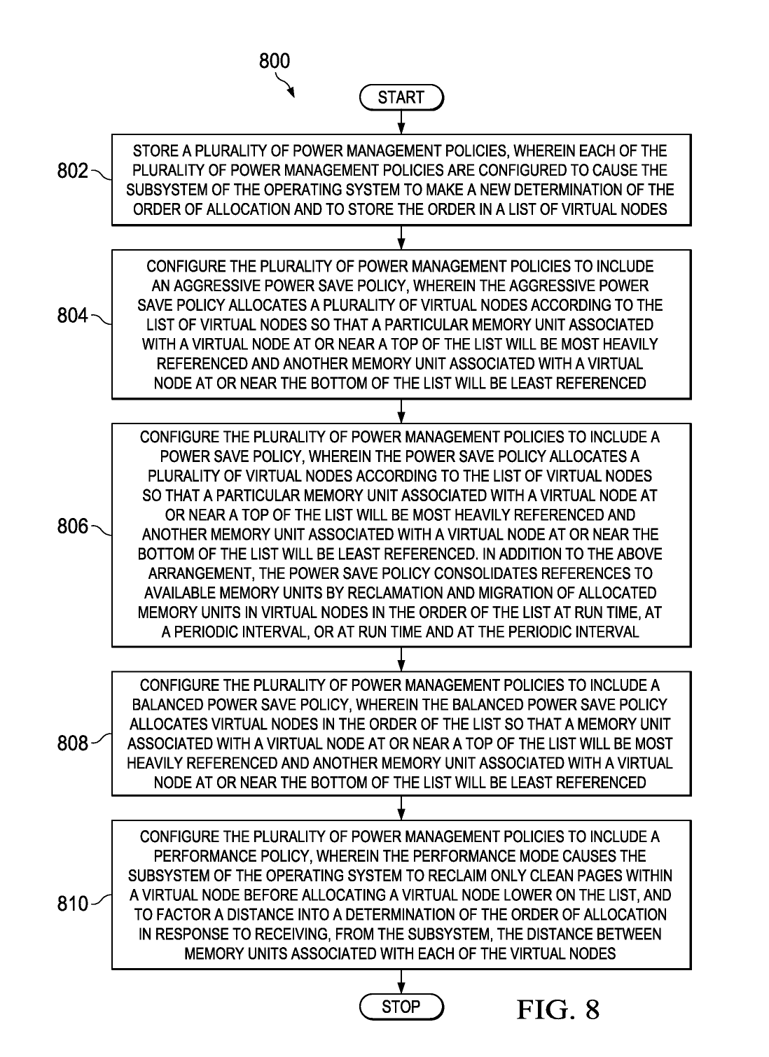

Referring to FIG. 8, a flowchart of a power saving configuration process is disclosed in accordance with an illustrative embodiment. Process 800 starts and stores a plurality of power management policies, wherein each of the plurality of power management policies are configured to cause the subsystem of the operating system to make a new determination of the order of allocation and to store the order in a list of virtual nodes (step 802). Power management policies may be policies 386 in FIG. 3. Process 800 configures the plurality of power management policies to include an aggressive power save policy, wherein the aggressive power save policy allocates a plurality of virtual nodes according to the list of virtual nodes so that a particular memory unit associated with a virtual node at or near a top of the list will be most heavily referenced and another memory unit associated with a virtual node at or near the bottom of the list will be least referenced (step 804). Virtual nodes may be virtual nodes 364 and the list may be list 378 in FIG. 3. In addition to the above arrangement, aggressive power save policy would consolidate references at periodic intervals by reclamation and migration of allocated memory units associated with the virtual nodes at near or bottom of the list so that they have the least memory references. Further, the aggressive power save policy could reduce the amount of virtual nodes available to the system using memory hot plug techniques so that memory units associated with unallocated virtual nodes are never referenced.

Process 800 configures the plurality of power management policies to include a power save policy, wherein the power save policy allocates a plurality of virtual nodes according to the list of virtual nodes so that a particular memory unit associated with a virtual node at or near a top of the list will be most heavily referenced and another memory unit associated with a virtual node at or near the bottom of the list will be least referenced. In addition to the above arrangement, the power save policy consolidates references to available memory units by reclamation and migration of allocated memory units in virtual nodes in the order of the list at run time, at a periodic interval, or at run time and at the periodic interval (step 806). Process 800 configures the plurality of power management policies to include a balanced power save policy, wherein the balanced power save policy allocates virtual nodes in the order of the list so that a memory unit associated with a virtual node at or near a top of the list will be most heavily referenced and another memory unit associated with a virtual node at or near the bottom of the list will be least referenced (step 808). Process 800 configures the plurality of power management policies to include a performance policy, wherein the performance mode causes the subsystem of the operating system to reclaim only clean pages within a virtual node before allocating a virtual node lower on the list, and to factor a distance into a determination of the order of allocation in response to receiving, from the subsystem, the distance between memory units associated with each of the virtual nodes (step 810). Process 800 ends.

The illustrative embodiments recognize and take into account that in a system that is not fully loaded, processors are idled. Since a system with processors idled runs under a smaller set of processors, the virtual nodes associated with the smaller set of processors receive more requests for memory, and the virtual nodes associated with the other processors receive less requests for memory. In an illustrative embodiment, the subsystem selects a virtual node and transfers page references to memory units assigned to a non-idle processor. In an illustrative embodiment, virtual nodes may be taken offline. Taking virtual nodes offline may be referred to as “hot-unplugging” the virtual nodes.

In an illustrative embodiment, memory reclaim may be performed with a virtual node before attempting to allocate memory from a different virtual node. For example, in a performance mode, only clean pages may be reclaimed before sending data to other virtual nodes. In an illustrative embodiment, memory hardware tracks a rate at which different memory units are being sent data. In an illustrative embodiment, memory interleaving may be controlled prior to boot up to facilitate power management. In a further illustrative embodiment, policies 386 in power management 382 may include a policy that a virtual node such as virtual node 366 that has been taken off line may be brought online in order to meet a performance criteria. The illustrative embodiments recognize and take into account that policies may be included in policies 386 that may affect a number of balances between saving power from memory allocation and performance demands or criteria for a computing system such as computing system in FIG. 3.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein; for example, in baseband or as part of a carrier wave. Such a propagated signal may take any of a variety of forms including, but not limited to, electro-magnetic, optical or any suitable combination thereof. A computer readable signal medium may be any computer readable medium that is not a computer readable storage medium and that can communicate, propagate or transport a program for use by or in connection with an instruction execution system, apparatus or device. Program code embodied in a computer readable signal medium may be transmitted using any appropriate medium including, but not limited to, wireless, wire line, optical fiber cable, RF, etc., or any suitable combination of the foregoing.

Computer program code for carrying out operations of the present invention may be written in any combination of one or more programming languages, including an object oriented programming language such as Java™, Smalltalk, C++ or the like, and conventional procedural programming languages, such as the “C” programming language or similar programming languages. (Java and all Java-based trademarks and logos are trademarks of Sun Microsystems, Inc., in the United States, other countries or both.) The program code may execute entirely on the user's computer, partly on the user's computer, as a stand-alone software package, partly on the user's computer and partly on a remote computer, or entirely on a remote computer or server. In the latter scenario, the remote computer may be operably coupled to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus, systems and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instructions which implement the function/act specified in the flowchart and/or block diagram block or blocks. The computer program instructions may also be loaded onto a computer or other programmable data processing apparatus to cause a series of operational steps to be performed in the computer or other programmable apparatus to produce a computer-implemented process, such that the instructions that execute in the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more runable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” as used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

Aspects of the present invention have been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method comprising:
determining, by a subsystem of an operating system, an order of allocation of a plurality of virtual nodes calculated to maintain a maximum number of a plurality of memory units devoid of references;
allocating the plurality of virtual nodes in the order of allocation; and
transitioning, by a memory controller, one or more memory units into a lower power state in response to the one or more memory units being devoid of one or more references for a period of time.

2. The method of claim 1 further comprising:
identifying, by a firmware, a plurality of memory units in a memory hardware, wherein each of the plurality of memory units is a portion of the memory hardware configured for power management by the memory controller of the memory hardware in response to the portion of the memory hardware being devoid of references for the period of time;
identifying, by the firmware, a configuration of the plurality of memory units;
sending, by the firmware, the configuration to the operating system;
reorganizing, by a kernel of the operating system, the plurality of memory units into the plurality of virtual nodes in a virtual non-uniform memory access architecture in response to receiving the configuration;
migrating data, by the subsystem, from a number of memory units in a number of virtual nodes to a one or more other memory units in one or more other virtual nodes to cause the number of memory units to be devoid of references for the period of time, wherein a migration of data is performed at run time, or at a periodic interval, or at run time and at the periodic interval in accordance with a mechanism selected by a policy configured for power management; and
making a new determination of the order of allocation, by the subsystem, in response to the migration of data.

3. The method of claim 1 further comprising:
configuring the operating system to emulate a non-uniform memory access architecture with a virtual non-uniform memory access architecture;
deactivating a memory interleaving function prior to receiving the configuration from the firmware;
removing one or more virtual nodes with free memory from the list in order to further concentrate references in a number of virtual nodes at or near the top of the list; and
adding a virtual node back to the list in response to all virtual nodes on the list being substantially full;
wherein the topology comprises a number of the plurality of memory units and for each of the plurality of memory units, a start address and a size.

4. The method of claim 1 further comprising:
storing a plurality of power management policies, wherein each of the plurality of power management policies are configured to cause the subsystem of the operating system to make a new determination of a mechanism to be used to save power consumed by memory.

5. The method of claim 4 further comprising:
configuring the plurality of power management policies to include an aggressive power save policy, wherein the aggressive power save policy allocates a plurality of virtual nodes according to a list of virtual nodes so that a particular memory unit associated with a virtual node at or near a top of the list will be most heavily referenced and another memory unit associated with a virtual node at or near the bottom of the list will be least referenced;
configuring the plurality of power management policies to consolidate references at periodic intervals by a reclamation and a migration of allocated memory units associated with the virtual nodes at near or a bottom of the list so that the virtual nodes at or near the bottom of the list have a least amount of memory reference; and
configuring the plurality of power management policies to reduce an amount of virtual nodes available to the system using a number of memory hot plug techniques so that a number of memory units associated with a number of unallocated virtual nodes are never referenced.

6. The method of claim 4 further comprising:
configuring the plurality of power management policies to include a power save policy, wherein the power save policy consolidates references to available memory in virtual nodes in the order of the list at run time, at a periodic interval, or at run time and at a periodic interval using data migration techniques.

7. The method of claim 4 further comprising:
configuring the plurality of power management policies to include a balanced power save policy, wherein the balanced power save policy allocates virtual nodes in the order of the list so that a memory unit associated with a virtual node at or near a top of the list will be most heavily referenced and another memory unit associated with a virtual node at or near the bottom of the list will be least referenced.

8. The method of claim 4 further comprising:
configuring the plurality of power management policies to include a performance policy, wherein the performance mode causes the subsystem of the operating system to reclaim only clean pages within a virtual node before allocating a virtual node lower on the list; and
configuring the plurality of power management policies to factor a distance into a determination of the order of allocation in response to determining, by the subsystem, the distance between memory units associated with each of the virtual nodes.

9. A system comprising:
a number of processors operably coupled to a number of computer readable storage mediums;
an operating system stored in one or more of the computer readable storage mediums;
a kernel in the operating system configured, in response to receiving a configuration of a memory hardware from a firmware, to reorganize the configuration into a number of virtual nodes in a virtual non-uniform memory access architecture and to place the number of virtual nodes in an order of allocation; and
a subsystem in the operating system that allocates the plurality of virtual nodes in the order of allocation;
wherein a memory controller transitions one or more memory units into a lower power state in response to the one or more memory units being devoid of one or more references for a period of time.

10. The system of claim 9 further comprising:
a firmware configured to identify a plurality of memory units in the memory hardware, wherein each of the plurality of memory units is a portion of the memory hardware configured for power management by the memory controller of the memory hardware in response to the portion of the memory hardware being devoid of references for the period of time, to identify the configuration of the plurality of memory units, and to send the configuration to the operating system;
wherein the subsystem migrates data from a number of memory units in a number of virtual nodes to one or more other memory units in one or more other virtual nodes to cause the number of memory units to be devoid of references for the period of time, wherein a migration of data is performed at run time, at a periodic interval, or at run time and at the periodic interval; and
wherein the subsystem makes a new determination of the order of allocation, by the subsystem, in response to the migration of data.

11. The system of claim 9 further comprising:
wherein the operating system is configured to emulate a non-uniform memory access architecture with a virtual non-uniform memory access architecture;
wherein a memory interleaving function is deactivated prior to receiving the configuration from the firmware;
wherein one or more virtual nodes having unreferenced memory are removed from the list in order to further concentrate references in a number of virtual nodes at or near the top of the list;
wherein a virtual node is added back to the list in response to all virtual nodes on the list being substantially full; and
wherein the topology comprises a number of the plurality of memory units and for each of the plurality of memory units, a start address and a size.

12. The system of claim 9 further comprising:
wherein the subsystem stores a plurality of power management policies, wherein each of the plurality of power management policies are configured to cause the subsystem of the operating system to make a new determination of the order of allocation and to store the order in a list.

13. The system of claim 12 further comprising:
wherein the plurality of power management policies are configured to include an aggressive power save policy, wherein the aggressive power save policy allocates a plurality of virtual nodes according to a list of virtual nodes so that a particular memory unit associated with a virtual node at or near a top of the list will be most heavily referenced and another memory unit associated with a virtual node at or near the bottom of the list will be least referenced;
wherein references are consolidated at periodic intervals by a reclamation and a migration of allocated memory units associated with the virtual nodes at near or a bottom of the list so that the virtual nodes at or near the bottom of the list have a least amount of memory reference; and
wherein an amount of virtual nodes available to the system are reduced using a number of memory hot plug techniques so that a number of memory units associated with a number of unallocated virtual nodes are never referenced.

14. The system of claim 12 further comprising:
wherein the plurality of power management policies are configured to include a power save policy, wherein the power save policy consolidates references to available memory in virtual nodes in the order of the list at run time, at a periodic interval, or at run time and at a periodic interval using data migration techniques.

15. The method of claim 12 further comprising:
wherein the plurality of power management policies are configured to include a balanced power save policy, wherein the balanced power save policy allocates virtual nodes in the order of the list so that a memory unit associated with a virtual node at or near a top of the list will be most heavily referenced and another memory unit associated with a virtual node at or near the bottom of the list will be least referenced.

16. The system of claim 12 further comprising:
wherein the plurality of power management policies are configured to include a performance policy, wherein the performance mode causes the subsystem of the operating system to reclaim only clean pages within a virtual node before allocating a virtual node lower on the list; and
wherein a distance is factored into a determination of the order of allocation in response to determining, by the subsystem, the distance between memory units associated with each of the virtual nodes.

17. A computer program product comprising:
a computer readable storage medium having computer readable program code embodied therewith, the computer readable program code comprising:
computer readable program code configured to operably couple the computer readable storage medium to an operating system stored in one or more of a plurality of computer readable storage mediums;
computer readable program code configured to operably couple the computer readable medium to a kernel in the operating system configured, in response to receiving a configuration of a memory hardware from a firmware, to reorganize the configuration into a number of virtual nodes in a virtual non-uniform memory access architecture and to place the number of virtual nodes in an order of allocation;
computer readable program code configured to operably couple the computer readable storage medium to a subsystem in the operating system that allocates the plurality of virtual nodes in the order of allocation, wherein a memory controller transitions one or more memory units into a lower power state in response to the one or more memory units being devoid of one or more references for a period of time; and
computer program instructions to store a plurality of power management policies, wherein each of the plurality of power management policies are configured to cause the subsystem of an operating system to make a new determination of an order of allocation and to store the order in a list.

18. The computer program product of claim 17 further comprising:
computer readable program code configured to operably couple the computer readable storage medium to a firmware configured to identify a plurality of memory units in the memory hardware, wherein each of the plurality of memory units is a portion of the memory hardware configured for power management by the memory controller of the memory hardware in response to the portion of the memory hardware being devoid of references for the period of time, to identify the configuration of the plurality of memory units, and to send the configuration to the operating system;
computer readable program code to configure the plurality of power management policies to include a power save policy, wherein the power save policy allocates a plurality of virtual nodes according to a list of virtual nodes so that a particular memory unit associated with a virtual node at or near a top of the list will be most heavily referenced and another memory unit associated with a virtual node at or near the bottom of the list will be least referenced.

19. The computer program product of claim 17 further comprising:
computer readable program code to configure the plurality of power management policies to include an aggressive power save policy, wherein the aggressive power save policy consolidates references to available memory in virtual nodes in the order of the list at run time, at a periodic interval, or at run time and at a periodic interval, or at a number of intervals in addition to run time; and
computer readable program code to configure the plurality of power management policies to include a balanced power save policy, wherein the balanced power save policy allocates virtual nodes in the order of the list so that a memory unit associated with a virtual node at or near a top of the list will be most heavily referenced and another memory unit associated with a virtual node at or near the bottom of the list will be least referenced, and to remove virtual nodes having memory units that are not being referenced from the list.

20. The computer program product of claim 19 further comprising:
computer readable program code to configure the plurality of power management policies to include a performance policy, wherein the performance mode causes the subsystem of the operating system to reclaim only clean pages within a virtual node before allocating a virtual node lower on the list.
